(19) United States
(12) Patent Application Publication
(10) Pub. No.: US 2023/0087159 A1
(43) Pub. Date: Mar. 23, 2023

(54) APPARATUS AND METHOD FOR IMPLEMENTING USER PLANE FUNCTION

(71) Applicant: Telefonaktiebolaget LM Ericsson (publ), Stockholm (SE)

(72) Inventors: Weiqiang Jiang, BEIJING (CN); Xin Nie, SHANGHAI (CN); Jun Wu, SHANGHAI (CN)

(21) Appl. No.: 17/802,619

(22) PCT Filed: Mar. 13, 2020
(86) PCT No.: PCT/CN2020/079261

§ 371 Date: Aug. 26, 2022

(51) Int. Cl. H04L 45/64; H04L 45/02

(52) U.S. Cl. CPC H04L 45/64; H04L 45/02

(57) ABSTRACT

The present disclosure provides an apparatus for implementing User Plane Function, UPF. The apparatus includes: a Field Programmable Gate Array, FPGA, configured to forward user plane data between a terminal device and a server; and a processor connected to the FPGA and configured to receive control information from a core network and transfer the control information to the FPGA for controlling the forwarding of the user plane data.

### TECHNICAL FIELD

The present disclosure relates to communication technology, and more particularly, to an apparatus and a method for implementing a User Plane Function (UPF).

### BACKGROUND

Edge Computing (EC) is an important feature brought by the 5^{th} Generation (5G) technology for providing a connection between an operator network and an enterprise Information Technology (IT) service network at the edge of the network, via a Radio Access Network (RAN) and in close proximity to users. EC aims to reduce latency, ensure highly efficient and secure networks, and offer improved user experiences.

FIG. 1 shows a conventional architecture for an EC solution. As shown, an operator’s 5G core control plane includes, among others, a Network Repository Function (NRF), a Policy Control Function (PCF), a Unified Data Management (UDM), a Network Exposure Function (NEF), an Authentication Server Function (AUSF), an Access and Mobility Management Function (AMF), and a Session Management Function (SMF). The AMF is connected to a User Equipment (UE) via an N1 interface and an Access Network (AN) via an N2 interface. A User Plane Function (UPF) is implemented in an EC platform and is connected to the AN via an N3 interface and the SMF via an N4 interface. The EC platform further includes standard X86 servers, switches and routers, a hypervisor layer (Virtual Machine (VM) / Container), a (Virtualized Infrastructure Manager) VIM, a firewall and a Mobile Edge Platform (MEP) which is connected to a Mobile Edge Platform Manager (MEPM). Moreover, applications (APPs) in an enterprise server need to migrate to the EC platform, as indicated by the arrow in FIG. 1. Such migration is a challenging task for both the operator and the enterprise, as the EC platform is developed by the operator while the APPs are typically customized and/or developed on a dedicated Operating System (OS) for the enterprise. Thus, the migration of the APPs could take significant efforts due to various differences between the operator’s EC platform and the enterprise’s IT environment.

In addition, the EC platform is typically built on a virtualization layer (such as OpenStack) and a containerization layer (such as Kubernetes, also known as K8S). In this case, the UPF or Containerized Network Function (CNF) / Virtualized Network Function (VNF) is heavily dependent on cloud platforms such as OpenStack or K8S. These layers/platforms require 4 or 6 X86 servers, resulting in a high cost. Furthermore, the EC solution as shown in FIG. 1 has relatively long delivery time (e.g., more than one month), including two weeks for hardware delivery, as well as time for Network Function Virtualization Infrastructure (NFVI) installation, UPF installation, and interconnection troubleshooting.

### SUMMARY

It is an object of the present disclosure to provide an apparatus and a method for implementing UPF, capable of solving at least one of the above described problems.

According to a first aspect of the present disclosure, an apparatus for implementing UPF is provided. The apparatus includes: a Field Programmable Gate Array (FPGA) configured to forward user plane data between a terminal device and a server; and a processor connected to the FPGA and configured to receive control information from a core network and transfer the control information to the FPGA for controlling the forwarding of the user plane data.

In an embodiment, the user plane data may include first user plane data from the server and to be forwarded to the terminal device, and/or second user plane data from the terminal device and to be forwarded to the server.

In an embodiment, the FPGA may be configured to forward the first user plane data to the terminal device, and/or receive the second user plane data from the terminal device, via a Radio Access Network (RAN) using General Packet Radio Service (GPRS) Tunneling Protocol - User Plane (GTP-U).

In an embodiment, the control information may include: first Packet Data Unit (PDU) session information for forwarding the first user plane data, including one or more of: an Internet Protocol (IP) address of the terminal device, a first Tunnel Endpoint Identifier (TEID) associated with the terminal device, or an IP address of an interface to the RAN, and/or second PDU session information for forwarding the second user plane data, including one or more of: the IP address of the terminal device, or a second TEID associated with the terminal device.

In an embodiment, the FPGA may include a memory storing a first table containing the first PDU session information and a second table containing the second PDU session information.

In an embodiment, the FPGA may be configured to receive the first user plane data from the server, and/or forward the second user plane data to the server, using IP.

In an embodiment, the FPGA may be further configured to transfer the user plane data to the processor, and the processor is configured to forward the user plane data based on the control information.

In an embodiment, the processor may be connected to the FPGA via Direct Memory Access (DMA).

In an embodiment, the FPGA and the processor may share a physical layer port.

In an embodiment, the processor may be an Advanced Reduced Instruction Set Computing (RISC) Machine (ARM) based processor.

In an embodiment, the FPGA and the processor may form a System on Chip (SoC).

In an embodiment, the apparatus may be applied in an EC platform co-located with the server.

According to a second aspect of the present disclosure, a method for implementing UPF is provided. The method includes: receiving, by a processor, control information from a core network; transferring, by the processor, the control information to an FPGA; and forwarding, by the FPGA, user plane data between a terminal device and a server based on the control information.

In an embodiment, the user plane data may include first user plane data from the server and to be forwarded to the terminal device, and/or second user plane data from the terminal device and to be forwarded to the server.

In an embodiment, the first user plane data may be forwarded to the terminal device, and/or the second user plane data may be received from the terminal device, via a RAN using GTP-U.

In an embodiment, the control information may include: first PDU session information for forwarding the first user plane data, including one or more of: an IP address of the terminal device, a first TEID associated with the terminal device, or an IP address of an interface to the RAN, and/or second PDU session information for forwarding the second user plane data, including one or more of: the IP address of the terminal device, or a second TEID associated with the terminal device.

In an embodiment, the method may further include: storing, by the FPGA, a first table containing the first PDU session information and a second table containing the second PDU session information in a memory.

In an embodiment, the first user plane data may be received from the server, and/or the second user plane data may be forwarded to the server, using IP.

In an embodiment, the method may further include: transferring, by the FPGA, the user plane data to the processor; and forwarding, by the processor, the user plane data based on the control information.

In an embodiment, the processor may be connected to the FPGA via DMA.

In an embodiment, the FPGA and the processor may share a physical layer port.

In an embodiment, the processor may be an ARM based processor.

In an embodiment, the FPGA and the processor may form a SoC.

In an embodiment, the method may be applied in an EC platform co-located with the server.

With the embodiments of the present disclosure, a UPF can be implemented with an FPGA for user plane functions (e.g., GTP-U based forwarding) and a processor for control plane functions (e.g., control of the forwarding). The UPF is “bare metal” based and relies on the FPGA and the processor only, with no intermediate layer between applications and hardware. The UPF can be implemented with a much lower cost, and is faster and easier to deploy, e.g., in a plug and play manner. Moreover, no migration effort is required for the enterprise or the operator, as the UPF is implemented without any OS, such that the enterprise IT environment can remain as it is when operating with the EC platform.

### BRIEF DESCRIPTION OF THE DRAWINGS

The above and other objects, features and advantages will be more apparent from the following description of embodiments with reference to the figures, in which:

FIG. 1 is a schematic diagram showing a conventional architecture for an EC solution;

FIG. 2 is a schematic diagram showing an exemplary architecture for an EC solution according to an embodiment of the present disclosure;

FIG. 3 is a block diagram of an apparatus for implementing UPF as well as a network scenario in which it is deployed, according to an embodiment of the present disclosure;

FIG. 4 is a schematic diagram showing a particular structure of the apparatus in FIG. 3;

FIG. 5 is a schematic diagram showing another particular structure of the apparatus in FIG. 3; and

FIG. 6 is a flowchart illustrating a method for implementing UPF according to an embodiment of the present disclosure.

### DETAILED DESCRIPTION

In the following description and claims, unless defined otherwise, all technical and scientific terms used herein have the same meaning as commonly understood by one of ordinary skills in the art to which this disclosure belongs.

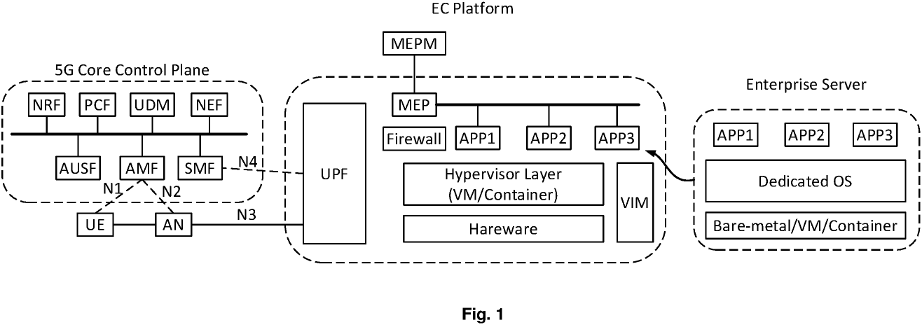

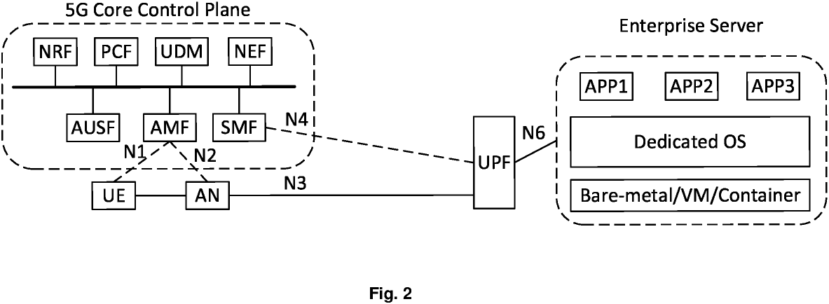

FIG. 2 is a schematic diagram showing an exemplary architecture for an EC solution according to an embodiment of the present disclosure. As shown, the UPF can be moved to be co-located with an enterprise server, e.g., in an enterprise IT environment. For example, the UPF can be directly connected to a router or switch in the enterprise IT environment, or directly inserted to a service computer in the enterprise IT environment as a Peripheral Component Interconnect express (PCIe) card. The UPF can be deployed within one day or several hours or even minutes. When compared with the architecture shown in FIG. 1, in this architecture the costs for the hypervisor layer, hardware and VIM as shown in FIG. 1 can be saved. More importantly, no migration of APPs from the enterprise IT environment to the operator’s EC platform is required.

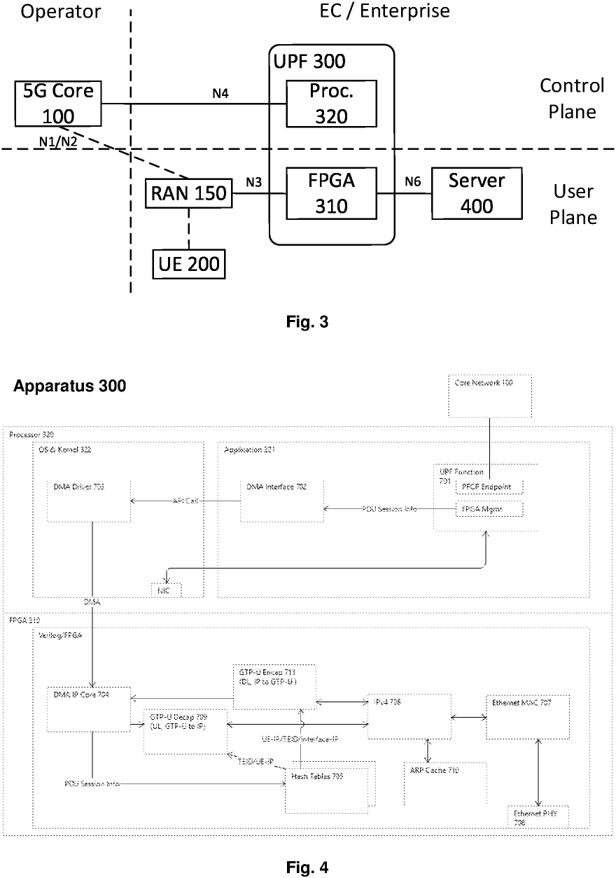

FIG. 3 is a block diagram of an apparatus 300 for implementing UPF as well as a network scenario in which it is deployed, according to an embodiment of the present disclosure. As shown, the apparatus 300 can be provided in an EC platform co-located with a server 400, e.g., in an enterprise IT environment. The server 400 can be an enterprise server, a cloud server, or any appropriate device hosting e.g., enterprise APPs.

The apparatus 300 includes an FPGA 310 and a processor 320. The processor 320 can be an ARM based processor (or alternatively, an X86 based processor). The FPGA 310 and the processor 320 can be integrated in a System on Chip (SoC) and can communicate with each other using DMA. DMA channels can be used to transfer control information and packet data at a high speed. Alternatively, the FPGA 310 and the processor 320 can be separate and can be connected via an Inter-Integrated Circuit (I2C) bus to work as one system.

The FPGA 310 is configured to forward user plane data between a terminal device (or UE) 200 and a server 400. As shown, the FPGA 310 can communicate with a RAN 150 (which serves the UE 200 via an air interface) via an N3 interface using e.g., GTP-U and with the server 400 via an N6 interface using e.g., IP. The processor 320 is connected to the FPGA 310, e.g., via DMA, and configured to receive control information from a core network (e.g., 5G core network) 100 and transfer the control information to the FPGA 310 for controlling the forwarding of the user plane data. The processor 320 can communicate with the core network 100 via an N4 interface using e.g., Packet Forwarding Control Protocol (PFCP).

Here, the user plane data may include user plane data from the server 400 and to be forwarded to the UE 200, referred to as downlink data hereinafter, and/or user plane data from the UE 200 and to be forwarded to the server 400, referred to as uplink data hereinafter. The FPGA 310 can be configured to forward the downlink to the UE 200, and/or receive the uplink data from the UE 200, via the RAN 150 using GTP-U (over the N3 interface). The FPGA 310 can be configured to receive the downlink data from the server 400, and/or forward the uplink data to the server 400, using IP (over the N6 interface).

Accordingly, the control information may include first PDU session information (downlink PDU session information) for forwarding the downlink data, including one or more of: an IP address of the UE 200, a first TEID (TEID for downlink) associated with the UE 200, or an IP address of an interface to the RAN 150. Additionally or alternatively, the control information may include second PDU session information (uplink PDU session information) for forwarding the uplink data, including one or more of: the IP address of the UE 200, or a second TEID (TEID for uplink) associated with the UE 200.

In an example, the FPGA 310 may include a memory storing a first table (e.g., a hash table for downlink) containing the first PDU session information and a second table (e.g., a hash table for uplink) containing the second PDU session information.

Optionally, the FPGA 310 can be further configured to transfer the user plane data to the processor 320, and the processor 320 can be configured to forward the user plane data based on the control information. The FPGA 310 can handle GTP-U based forwarding in real time. When features such as Packet Detection Rule (PDR), Forwarding Action Rule (FAR), Quality of Service (QoS) Enhancement Rule (QER), Buffering Action Rule (BAR), or any combination thereof, are to be supported, the user plane data can be transferred to the processor 320 for forwarding.

FIG. 4 is a schematic diagram showing a particular structure of the apparatus 300 in FIG. 3. As shown, the processor (e.g., ARM processor) 320 can include an application module 321 and an OS/kernel 322. The application module 321 can include a UPF function 701 having a PFCP endpoint connected to a Network Interface controller (NIC) and configured to communicate with the core network 100 for receiving the control information (downlink (DL) and/or uplink (UL) PDU session information) and an FPGA management module configured to transfer the control information to a DMA interface 702. The FPGA management module is used for providing and updating the control information to the FPGA 310 and collecting FPGA traffic statistics and counters. The control information is then transferred to a DMA driver 703 in the OS/kernel 322 by means of Application Programming Interface (API) call, and then to a DMA IP core 704 in the FPGA 310 by means of DMA. The control information is stored in hash tables 705, e.g., the DL PDU session information is stored in a hash table for DL and the UL PDU session information is stored in a hash table for UL.

For UL forwarding, the FPGA 310 can receive UL data from a UE (e.g., UE 200 in FIG. 3) via a RAN (e.g., RAN 150 in FIG. 3) using a physical layer (PHY) port (e.g., an Ethernet PHY port) 706 (over N3 interface). The UL data is then subjected to Media Access Control (MAC) frame decoding and Cyclic Redundancy Check (CRC) at an Ethernet MAC module 707, and IP packet decoding and IP address matching for the N3 interface at an IP (e.g., IP version 4 or IPv4) module 708. The UL data is also subjected to multiplexing and packet filtering on protocol types, checksums, IP addresses and User Datagram Protocol (UDP) ports. A GTP-U decapsulation module 709 extracts a TEID from the UL data and queries the UL PDU session information (including e.g., IP address of the UE and UL TEID of the UE) from the hash tables 705. The UL data/packet will be handled based on the query result from the hash tables 705. The GTP-U decapsulation module 709 removes a GTP-U header for packets with a valid TEID and transfers the decoded GTP-U inner packet to the IPv4 module 708 for forwarding to a server (e.g., server 400 in FIG. 3) (over N6 interface). The FPGA 310 can also include an Address Resolution Protocol (ARP) Cache 710 for address resolution.

For DL forwarding, the FPGA 310 can receive DL data from a server (e.g., server 400 in FIG. 3) using the Ethernet PHY port 706 (over N6 interface). The DL data is then subjected to MAC frame decoding and CRC at an Ethernet MAC module 707, and IP packet decoding and IP checksum verification at the IPv4 module 708. A GTP-U encapsulation module 711 queries the DL PDU session information (including e.g., IP address of the UE, DL TEID of the UE, and IP address of an interface to RAN (e.g., RAN 150 in FIG. 3)) based on a destination IP address from the hash tables 705. The DL data/packet will be handled based on the query result from the hash tables 705. The GTP-U encapsulation module 711 constructs a GTP-U packet header based on the DL PDU session information, recalculates an IP checksum and forwards a resulting GTP-U packet to a UE (e.g., UE 200 in FIG. 3) via the RAN 150 using the Ethernet PHY port 706 (over N3 interface). Optionally, the GTP-U encapsulation module 711 may transfer the GTP-U packet to the processor 320 for forwarding to the UE 200.

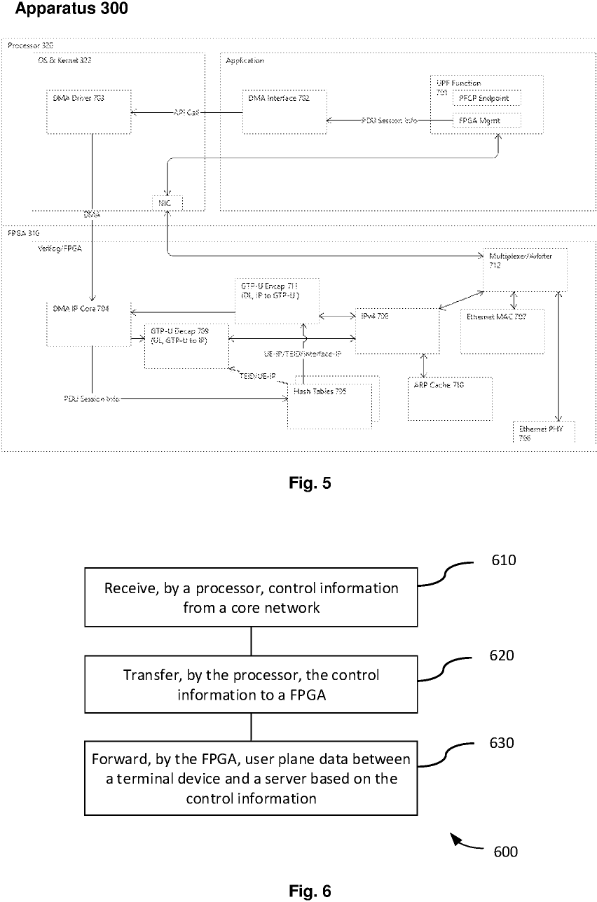

FIG. 5 is a schematic diagram showing another particular structure of the apparatus 300 in FIG. 3. It differs from the structure shown in FIG. 4 in that the FPGA 310 and the processor 320 share a physical layer (PHY) port (e.g., an Ethernet PHY port) 706. In other words, the Ethernet PHY port 706 can be shared by the N3, N4 and N6 interfaces. In this case, the FPGA 310 and the processor 320 may use different IP addresses. The processor 320 may have its own ARP module, which can be implemented in the OS/Kernel 322. The FPGA 310 may include a multiplexer/arbiter 712 for directing data/traffic to the FPGA 310 or the processor 320. For example, the multiplexer/arbiter 712 can be configured to receive an IP packet with a MAC address from the IPv4 module 708 and forward it to the MAC module 707, or receive a MAC frame with an Ethernet payload and a MAC address and forward it to the MAC module 707.

FIG. 6 is a flowchart illustrating a method 600 according to an embodiment of the present disclosure. The method 600 can be performed by the apparatus 300 as described above.

At block 610, a processor (e.g., processor 320 in FIG. 3) receives control information from a core network.

At block 620, the processor transfers the control information to an FPGA (e.g., FPGA 310 in FIG. 3).

At block 630, the FPGA forwards user plane data between a terminal device and a server based on the control information.

In an embodiment, the user plane data may include first user plane data from the server and to be forwarded to the terminal device, and/or second user plane data from the terminal device and to be forwarded to the server.

In an embodiment, the first user plane data may be forwarded to the terminal device, and/or the second user plane data may be received from the terminal device, via a RAN using GTP-U.

In an embodiment, the control information may include: first PDU session information for forwarding the first user plane data, including one or more of: an IP address of the terminal device, a first TEID associated with the terminal device, or an IP address of an interface to the RAN, and/or second PDU session information for forwarding the second user plane data, including one or more of: the IP address of the terminal device, or a second TEID associated with the terminal device.

In an embodiment, the method 600 may further include: storing, by the FPGA, a first table containing the first PDU session information and a second table containing the second PDU session information in a memory.

In an embodiment, the first user plane data may be received from the server, and/or the second user plane data may be forwarded to the server, using IP.

In an embodiment, the method 600 may further include: transferring, by the FPGA, the user plane data to the processor; and forwarding, by the processor, the user plane data based on the control information.

In an embodiment, the processor may be connected to the FPGA via DMA.

In an embodiment, the FPGA and the processor may share a physical layer port.

In an embodiment, the processor may be an ARM based processor.

In an embodiment, the FPGA and the processor may form a SoC.

In an embodiment, the method 600 may be applied in an EC platform co-located with the server.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. An apparatus for implementing User Plane Function, UPF, comprising:
a Field Programmable Gate Array, FPGA, configured to forward user plane data between a terminal device and a server; and
a processor connected to the FPGA and configured to receive control information from a core network and transfer the control information to the FPGA for controlling the forwarding of the user plane data.

2. The apparatus of claim 1, wherein the user plane data comprises first user plane data from the server and to be forwarded to the terminal device, and/or second user plane data from the terminal device and to be forwarded to the server.

3. The apparatus of claim 2, wherein the FPGA is configured to forward the first user plane data to the terminal device, and/or receive the second user plane data from the terminal device, via a Radio Access Network, RAN, using General Packet Radio Service ‘GPRS’ Tunneling Protocol - User Plane, GTP-U.

4. The apparatus of claim 3, wherein the control information comprises:
first Packet Data Unit, PDU, session information for forwarding the first user plane data, including one or more of: an Internet Protocol, IP, address of the terminal device, a first Tunnel Endpoint Identifier, TEID, associated with the terminal device, or an IP address of an interface to the RAN, and/or
second PDU session information for forwarding the second user plane data, including one or more of: the IP address of the terminal device, or a second TEID associated with the terminal device.

5. The apparatus of claim 4, wherein the FPGA comprises a memory storing a first table containing the first PDU session information and a second table containing the second PDU session information.

6. The apparatus of claim 2, wherein the FPGA is configured to receive the first user plane data from the server, and/or forward the second user plane data to the server, using IP.

7. The apparatus of claim 1, wherein the FPGA is further configured to transfer the user plane data to the processor, and the processor is configured to forward the user plane data based on the control information.

8. The apparatus of claim 1, wherein the processor is connected to the FPGA via Direct Memory Access, DMA.

9. The apparatus of claim 1, wherein the FPGA and the processor share a physical layer port.

10. The apparatus of claim 1, wherein the processor is an Advanced Reduced Instruction Set Computing ‘RISC’ Machine, ARM, based processor.

11. The apparatus of claim 1, wherein the FPGA and the processor form a System on Chip, SoC.

12. The apparatus of claim 1, wherein the apparatus is applied in an Edge Computing, EC, platform co-located with the server.

13. A method for implementing User Plane Function, UPF, comprising:
receiving, by a processor, control information from a core network;
transferring, by the processor, the control information to a Field Programmable Gate Array, FPGA; and
forwarding, by the FPGA, user plane data between a terminal device and a server based on the control information.

14. The method of claim 13, wherein the user plane data comprises first user plane data from the server and to be forwarded to the terminal device, and/or second user plane data from the terminal device and to be forwarded to the server.

15. The method of claim 14, wherein the first user plane data is forwarded to the terminal device, and/or the second user plane data is received from the terminal device, via a Radio Access Network, RAN, using General Packet Radio Service ‘GPRS’ Tunneling Protocol - User Plane, GTP-U.

16. The method of claim 15, wherein the control information comprises:
first Packet Data Unit, PDU, session information for forwarding the first user plane data, including one or more of: an Internet Protocol, IP, address of the terminal device, a first Tunnel Endpoint Identifier, TEID, associated with the terminal device, or an IP address of an interface to the RAN, and/or
second PDU session information for forwarding the second user plane data, including one or more of: the IP address of the terminal device, or a second TEID associated with the terminal device.

17. The method of claim 16, further comprising:
storing, by the FPGA, a first table containing the first PDU session information and a second table containing the second PDU session information in a memory.

18. The method of claim 14, wherein the first user plane data is received from the server, and/or the second user plane data is forwarded to the server, using IP.

19. The method of claim 13, further comprising:
transferring, by the FPGA, the user plane data to the processor; and
forwarding, by the processor, the user plane data based on the control information.

20. The method of claim 13, wherein the processor is connected to the FPGA via Direct Memory Access, DMA.

21. (canceled)

22. (canceled)

23. (canceled)

24. (canceled)
